(19) United States
(12) Patent Application Publication
(10) Pub. No.: US 2007/0283289 A1
(43) Pub. Date: Dec. 6, 2007

(54) COMMUNICATION SYSTEM FOR COMMUNICATING VIA A GRAPHICAL ELEMENT

(75) Inventors: Michael Greve, Karlsruhe (DE); Frank Schueler, Karlsruhe (DE); Christian Reissmueller, Sulzberg (DE); Dietmar Biener, Karlsruhe (DE)

Correspondence Address: DARBY & DARBY P.C., P.O. BOX 770, Church Street Station, New York, NY, 10008-0770, US

(73) Assignee: COMBOTS PRODUCT GMBH, Karlsruhe (DE)

(21) Appl. No.: 11/756,745

(22) Filed: Jun. 1, 2007

(30) Foreign Application Priority Data
Jun. 1, 2006 (DE) 10 2006 025 685.9
Jun. 1, 2006 (DE) 10 2006 025 686.7
Jun. 1, 2006 (DE) 10 2006 025 687.5

(51) Int. Cl. G09G 5/02

(52) U.S. Cl. 715/781; 345/592

(57) ABSTRACT

A communication system for communicating includes a window-based graphical user interface and a graphical element. The window-based graphical user interface is displayed on a display device. The window-based graphical user interface includes an area defined as a window, and the area is displayed transparently. The graphical element includes non-transparent pixels displayed in the window.

The present application claims priority to German Patent Application DE 10 2006 025 686.7, filed Jun. 1, 2006; German Patent Application DE 10 2006 025 687.5, filed June 1, 2006; and German Patent Application DE 10 2006 025 685.9, filed Jun. 1, 2006. Each of these applications is hereby incorporated by reference as if set forth in its entirety.

The present invention relates to a communication system for communicating. More specifically, the present invention relates to a communication system for communicating via a ComBOT™. ComBOT™ and CmBOTs™ are trademarks of ComBOTS Product GmbH.

### BACKGROUND

International Patent Publication WO 2005/076582, describes a communication system and a contact element, called ComBOT™, to be used therein. This ComBOT™ application includes graphical elements which allow two communication partners to be connected to each other exclusively at a time. Via the graphical elements, i.e., the so-called ComBOTs™, the two communication partners can communicate with each other exclusively, and, for example, exchange files by dragging and dropping a file onto this ComBOT™, have a telephone conversation with one another by activating a telephone function, exchange messages using messaging functions, etc.

During these activities, the so-called ComBOTs™ are preferably located, as graphical elements, on the desktop of a user interface in a computer. To be able to access these ComBOT™ applications on the desktop, they have to be integrated accordingly. Desktop objects known in the art include icons or windows. Icons may be mere symbols or clickable symbols such as links, and are subject to the desktop array, i.e., to the corresponding orientation on the grid. On the other hand, windows are not subject to the desktop array and can be freely moved and changed in size. In addition, windows are arranged hierarchically such that every sub-window has a so-called parent. The applications, which can be selected by the user in a window, run in the windows.

### SUMMARY

In an embodiment, the present invention provides a communication system for communicating. The system includes a window-based graphical user interface and a graphical element. The window-based graphical user interface is displayed on a display device. The window-based graphical user interface includes an area defined as a window, and the area is displayed transparently. The graphical element includes non-transparent pixels displayed in the window.

### BRIEF DESCRIPTION OF THE DRAWINGS

Exemplary embodiments of the present invention are explained in more detail below with reference to the accompanying drawings, in which:

FIG. 1 is a schematic view of an embodiment according to the present invention;

FIG. 2 is a schematic view of an embodiment according to the present invention;

FIG. 3 is a schematic view of an embodiment according to the present invention; and

FIG. 4A-4B is a schematic view of an embodiment according to the present invention, illustrating five different phases I through V.

An embodiment of the present invention provides a communication system which allows a ComBOT™ application to be accessed in an animated manner. The communication system includes a display screen on which a window-based graphical user interface can be displayed. One area is defined as a window which is displayed transparently or defined to be transparent. At least one graphical element composed of pixels which is displayable in the window is also provided, and the pixels are preferably not completely transparent.

Preferably, the ComBOT™ application can be accessed animatedly without requiring large memory resources.

In an embodiment of the present invention, the communication system (KE) includes a communication device (KEG) provided within the display device on which the window-based graphical user interface (DT): can be displayed. In this example, at least one graphical element (CB) can be animated by playing back a movie file (FD). Ideally, the movie file (DFD) is selected depending on properties of the graphical element and/or depending on properties of the communication device (KEG), and/or depending on an event to be represented.

Preferably, the communication system includes a display screen or display device on which a window-based graphical user interface (DT) can be displayed. At least one graphical element (LB) can be transferred from a basic animation into a communication animation using, for example, a movie file.

In an embodiment of the present invention, a communication system is the overall system of existing hardware and software components, including, in particular, communication devices, such as PDAs, cellular phones, personal computers, etc., and network systems, as well as servers on which the communication can be controlled over the network. In addition to the communication devices, it is preferred to also provide devices for establishing connections to the Internet, and, within the Internet, storage media, on which the communication may also be temporarily stored, if necessary.

Display devices or screens include displays, monitors, and other display devices for displaying text and images. Preferably, the displays are also capable of displaying text or graphics in color. It is also preferable that the display screens are displays that are integrated into the respective communication devices.

In an embodiment of the present invention, a window-based graphical user interface is an interface between a user and a communication device and is preferably displayed on the screen. The graphical user interface or desktop allows the user to enter commands via an input device such as the keypad, mouse, pointer, or via a touch screen. The graphical user interface is preferably window-based, which means that windows can be displayed on the user interface. Windows are desktop elements which can be moved and changed in size. Such windows are known from various graphically-oriented user interfaces of various operating systems such as MAC OS, Windows, Linux, etc.

In accordance with an embodiment of the present invention, the windows are displayed and/or animated transparently. Thus, the window is not shown with a frame or scroll bar, but is displayed transparently, and does not graphically appear to the user, or appears to the user as a type of “glass pane”. As a result of the transparent representation of the window, the functionality of a window can indeed be used, but without creating the visual impression of a window and without displaying the control and input mechanisms associated therewith. Thus, the transparent window can serve as a transparent platform on which the graphical element formed of pixels will then be displayed.

In accordance with the present invention, the graphical element, such as the graphical symbol of the ComBOT™ application, is then built up from individual pixels and displayed on the transparent window. Because the graphical elements formed of pixels are not completely transparent, the user of the communication system can then perceive them as graphical elements on the display screen. However, since the graphical elements are displayed in a transparent window element, they can be accessed and controlled using the usual commands that are embedded in the operating system and used for controlling and using a desktop element of the type “window”.

Thus, it is possible, for example, to move files onto the graphical element and drop them there, such as in a window. The style property of transparency of the window is set to zero, whereby the windows is displayed transparently. On the other hand, the graphical element has pixels that are not completely transparent, which allows it to be displayed on the transparent windows and be perceived by the user. If, for example, a mouse is then moved over this transparent window, it is possible to perceive that the mouse is located over the window. At the same time, it is also possible to detect that the mouse is located over the graphical element, because here the pixels are defined not to be completely transparent.

Thus, it is not necessary to track the exact position of the mouse pointer. Rather, it is possible to monitor whether, within the transparent window element, the mouse is located over a pixel that is not completely transparent. In this case, the mouse pointer is located over the graphical element. When, for example, a drag-and-drop action is to be performed, it is thus possible to detect that the mouse point is located over the graphical element in a special, transparently displayed window, while the mouse key is then released. Thus, the drag-and-drop function, which is then performed, can be associated with the respective graphical representation or ComBOT™. Thus, the known object “window” and the associated options for action and reaction are advantageously used in such a way that, using the window displayed transparently in the manner described hereinbefore, the graphical element “ComBOT™” is displayed, defined and made detectable by non-transparent pixels within this window.

Preferably, a communication system is provided in which the graphical element can be animated, especially by means of a BINK player. This allows the graphical element to be animated independently of the functionality of the transparent window. A window object per se cannot be animated, so that the graphical element can be animated on the transparent window using, for example, a BINK player.

As a result, the graphical element may, perform movements, and videos may be played which are animations of the graphical element, etc. Thus, it is possible to provide a graphical element in the form of, for example, a cartoon figure, for which a movie will then be played. The movie can be played on the transparent window using a BINK player. Thus, it appears to the observer that the graphical element performs specific movements and performs other actions predefined in the movie being played. In this manner, it is possible to communicate non-verbally, and to use these animations to convey an implied message.

BINK is a video file format (file extension bilk) and is mainly used in video games. This format has a video and audio codec of its own and supports resolutions of 320×240 pixels and higher, up to high definition video. A BINK player is an application that can play a file in BINK format. Thus, the sequence for animating the graphical element is preferably in the form of a BINK file.

Preferably, an embodiment of the present invention provides a communication system in which the non-transparent pixels can be detected by checking the transparency value or the alpha channel, and not only by the position of the mouse pointer. In this manner, independently of the determination of the exact coordinates of the mouse pointer, it can be checked whether the mouse pointer is located on the graphical element or ComBOT™, and thus on a responsive area, or whether the mouse pointer is located next to the ComBOT™ over the transparent, window. It is no longer necessary to determine the exact coordinates of the mouse pointer within the window in order to determine whether it is located over the graphical element or ComBOT™. Now, it is fully sufficient to determine that the mouse pointer is located over a non-transparent pixel, and that, therefore, the mouse points to the graphical element or ComBOT™. This allows the position over the ComBOT™ to be defined without having to use coordinates.

It is especially during animation of the graphical element or ComBOT™, during which the position of the graphical element can permanently change to this extent, that the definition regarding the position of the mouse pointer over a non-transparent pixel can thereby be perceived much faster, and is much more meaningful than the changing X and Y coordinates of the graphical element within the transparent window. Thus, instead of determining the exact coordinate position of the mouse in order to match it to the exact X and Y coordinate of the moving graphical element; it is only checked whether the mouse is located over a non-transparent pixel.

In an embodiment of the present invention, it is preferable that the communication system is provided in which the graphical element (CB) is in an image format with an alpha channel, especially in PNG format. The use of an alpha channel in the image format of the graphical element or ComBOT™ may allow the additional information about pixel transparency to be retrieved via this separate alpha channel. A preferred image format having this alpha channel is the PNG format.

The alpha channel is an additional color channel in digital images and stores the transparency of the individual pixels in addition to the color information encoded in a color space.

In various graphics formats (e.g., PNG, PSD, TGA, or TIFF), transparency information is stored in the alpha channel in addition to the actual image data. An alpha channel has the same color depth as a color channel of an image. For example, in the case of an 8-bit image, the alpha channel contains 256 levels of gray.

The maxim tin number of possible levels of transparency depends on the number of bits used for the alpha channel. A binary alpha channel is a minimum alpha channel which uses 1 bit and can therefore only indicate whether a pixel is completely transparent or completely opaque. This type of transparency is used in the GIF file format, but is not an alpha channel from a technical point of view, because transparency information is not stored separately for each pixel. Other formats often allow for an additional byte per pixel, thus providing 2⁸=256 levels.

In order to draw an image with an alpha channel over a background, the technique of alpha blending is used. Alpha channels can be defined in a variety of image processing programs. This makes it possible, for example, to store selections in the image for reuse at a later time. Alpha channels can also be used to crop an image. Frequently, this is done by copying an existing color channel to an alpha channel, after which it can be quickly edited using the image editing functions (curves, contrast, brush, etc.). Ant alpha channel can also be used in videos to separate objects from the background. The alpha channel can be stored directly with the video, or in a separate video file.

Portable Network Graphics (PNG) is a graphics format for raster graphics. It was designed as a free substitute for the older, proprietary GIF format and is less complex than TIFF. The files are stored in a lossless, compressed form, unlike the lossy JPEG file format. PNG is a universal format recognized by the World Wide Web Consortium, and is supported by modern Web browsers. In addition, PNG provides all the features offered by GIF, except for animations. In addition, the compression rate is usually better. This makes it a very useful format.

Like GIF, PNG can handle pixels from a color palette of up to 256 entries. In addition, it is possible to store grayscale images with 1, 2, 4, 8, or 16 bits, and RGB color images with 8 or 16 bits per channel, i.e., 24 or 48 bits per pixel, respectively.

PNG files can contain transparency information, either in the form of an alpha channel or for each color of the color palette. An alpha channel provides additional information for each pixel, indicating how much of the background of the image is to shine through. PNG supports 8- or 16-bit alpha channels, which corresponds to 256 or 65536 levels of transparency, respectively. In contrast, GIF only allows a single entry of the palette to be defined to be completely transparent. Thus, the PNG format enables smoothing of the edges of text and images, independently of the background. It is possible to use real drop shadows which fade in the background, or to create images of any shape, provided that a PNG-capable program is used for displaying the images.

In addition, the use of the PNG format allows early detection of errors in the file using integrated checksums. In addition, the PNG format is streamable, i.e., unlike, for example, in the case of many TIFF files, random access is not needed to interpret the contents of the file, and the PNG format offers an optional 7-pass interlacing scheme as proposed by Adam M. Costello (“Adam7”), according to which images are built up slowly during transmission over slow data links, such as in the Internet. At the same time, image distortion is less than in GIF. Relatively acceptable imaging quality can already be achieved at very low transmission rates.

In an embodiment of the present invention, it is preferable that the communication system is provided in which the window has a size of 372×256 pixels.

In an embodiment of the present invention, preferably, the so-selected format allows two graphical elements to be displayed next to each other. The graphical elements can then not only be animated individually, but can also communicate with each other, and be moved interactively in common animations. Thus, for example, one's own ComBOT™ can be displayed on one side, and the ComBOT™ or graphical element of the communication partner can be displayed on the other side. Then, for example, a non-verbal communication may take place through interactive animation of these two graphical elements or ComBOTs™.

Thus, it is possible, for example, to select an animation in which one's own ComBOT™ gives a bouquet of flowers to the ComBOT™ of the communication partner. This animation is preferably displayed as a movie, and appears to the observer as an animation of two graphical elements standing next to each other, since the observer is unable to see the transparent window in which the animation takes place. The same animation may be simultaneously displayed on the screen of the communication partner on the other end, so that the respective movie is displayed there as well, transmitting the non-verbal communication. The communication partner then sees that he/she is given a bouquet of flowers, and thereby receives the message of birthday greetings. Of course, on a window sized 372×256 pixels, it is also possible to display only one ComBOT™ or graphical element. In that case, the ComBOT™ may use the entire space of the underlying transparent window to move and be animated.

In this context, a movie file is a file containing, suitable movie sequences which are associated with the individual graphical elements or ComBOTs™, and which, when played, cause an animation of the ComBOT™. Thus, the user gets the impression that the ComBOT™ is moving according to the movie sequences in the movie file, Wand is animated in this manner. Preferably, the movie files changed in this manner can also be played in a loop, which means that they are shorter movie sequences that are repeated continuously. In addition, it is preferable that the representation of the graphical element or ComBOT™ at the beginning of this movie sequence is nearly identical to that at the end of the movie sequence, so that the observer does not see any “jump” in the movie sequence being displayed as the loop is running.

It is also preferred to use different movie files to produce different animations for the graphical element or ComBOT™. Thus, in a stand-by mode, the ComBOT™ may be animated in a very restrained fashion, for example by moving only the eyes of a displayed face, and/or by said face occasionally showing slight movements. Such an animation is a basic animation in which the ComBOT™ is animated as long as no communication requests are received from the partner of the ComBOT™. This animation can be used to represent the resting state of the ComBOT™ when the ComBOT™ is inactive. Other basic states in which the ComBOT™ indicates, for example, that messages have been received, or in which it provides status displays or other information, are also referred to as basic animations.

The ComBOT™ can be transferred from this basic animation into another type of animation, called communication animation, when suitably controlled by the user, or by the system, or by the communication partner of the user who is represented by the ComBOT™, Thus, for example, a message received from the user's communication partner who is represented by this ComBOT™ may cause this ComBOT™ to be transferred from an inactive mode, in which it makes only slight movements of the face or of the animated eyes, into a communication animation, thereby signaling to the user that, for example, a message has been received. Thus, in the communication animation, the ComBOT™ may then be displayed jumping and lifting an envelope on which a numeral indicating the number of received messages may be shown, this communication animation signaling to the user that a change has taken place in the state of the communication channel via this ComBOT™ to the associated communication partner.

In the process, the representation of the ComBOT™ is preferably transferred from the basic animation into a communication animation, i.e., the end of a movie sequence used for the basic animation is followed without interruption by the beginning of a movie sequence of a communication animation which gives the observer the impression that the graphical representation or the ComBOT™ is now displayed differently, indicating a change in the communication status. This conversion or transformation of the representation of the ComBOT™ from the basic animation into the communication animation may be associated with typical film editing techniques, such as cutting, cross-fading, fading in and out, etc. In the transparent window, at least one ComBOT™ or graphical element is displayed. Preferably, it is possible to display two graphical elements, one graphical element of which is used as a representative of the communication partner of the user of the communication device or system, while the second graphical element is the representative of the user himself/herself. For example, he/she is displayed as a ComBOT™ on the desktop of his/her communication partner.

By displaying two ComBOTs™ within the transparent window, it is flow possible to play movie sequences showing a non-verbal communication between these two ComBOTs™ or graphical representations. Thus, for example, the user's own ComBOT™ may be selected to convey greetings to the communication partner by choosing a corresponding non-verbal animation for the user's own ComBOT™ with respect to the other ComBOT™ associated with the other communication partner. This non-verbal animation may, for example, show the handing over of a bouquet of flowers. The user's own ComBOT™ is then animated to take a bow and give a bouquet of flowers to the ComBOT™ of the communication partner in this transparent window while both ComBOTs™ are displayed. The other ComBOT™ may then accept this bouquet of flowers while slightly blushing.

In accordance with an embodiment of the present invention, this non-verbal communication is accomplished by selecting a corresponding communication animation for the handing over of the bouquet of flowers from one ComBOT™ to the other, and then playing this movie accordingly. Preferably, this animation can also be displayed on the desktop of the communication partner on the other end, so that this non-verbal communication is displayed to the communication partner on his/her own desktop by a corresponding communication animation between the two ComBOTs™.

In addition, it is preferable that the movie file is selected depending on various parameters. For example, it is possible to account for the different types of communication devices, for the type of ComBOT™, or the type of graphical animation on the other hand, and/or for the type of event.

If the movie file is selected depending on properties of the graphical element, then it is possible to use a repertoire of animated movies specifically stored for a specific ComBOT™ and animation may exist for a particular graphical representation or ComBOT™, while there are m options for a different ComBOT™.

Additionally or alternatively, the movie is also selected depending on properties of the communication device, making it possible to account for specific features of the particular device. Thus, for example, a higher-resolution movie file may be played on a system with high computing power, while movie files using less memory may be accessed for smaller devices. The resolution of the particular display device may also have an impact on the movie file. Thus, it is possible to respond individually to the different devices.

Furthermore, it is possible to respond to events to be displayed, and to select the movie file accordingly. Thus, an animation and a movie file may differ depending on whether, for example, the settings for the visual appearance of the user's own ComBOT™ are changed by the user locally, or whether a corresponding message is input externally. Moreover, a movie file may be selected differently depending on the fact that an animation of the ComBOT™ is initiated by the user.

In an embodiments according to the present invention, a property of a communication device (KEG) includes one or more from the group of class, type, model, software, and user preference.

Thus, the selection of the movie or movie file for a particular animation of the ComBOT™ can be made depending on the communication device. In this connection, the device class, such as personal computer, PDA, telephone, may be considered as a parameter. Furthermore, it is possible to account for the type, such as, for example, features with respect to graphics cards, memory devices, screen size, etc. The model of the communication device, or the software version running thereon, may also be taken into account. Moreover, it is possible to check how many other programs are already running on the communication device and how much free memory is available for the ComBOT™ application order to select a suitable movie accordingly.

In addition, it is possible to account for user preferences that are generally entered by the user into his/her communication device, or selected for a particular ComBOT™ application. It is also possible to account for the time zone in which a communication device is used, so that a ComBOT™ animation uses different movie files, depending on whether the animation is to be animated during the day or at night, or at a specific time of the day. Similarly, the animated movie for the ComBOT™ may vary depending on the language that is used by the operating system of the communication device or which the user has entered for a particular ComBOT™ application. It is even possible to play only an audio file in place of a movie sequence and a corresponding file, depending on the type of device. For example, if the device is not a personal computer or a cellular phone with a large screen, it may only read out a text while an “empty movie” is played; which means that no movie is transferred at all.

In an embodiment according to the present invention, a property of the graphical element includes one or more from the group of category, size, and type.

The animations may also be selected differently depending on properties of the communication element or graphical element itself. Thus, each ComBOT™ may preferably have a specific appearance and a corresponding behavior or pattern of behavior. One ComBOT™ may, for example, be a small helicopter-like robot, which would then have the appearance “helicopter robot”. The reaction options available for this ComBOT™ for non-verbal communication and animation could then be n different communication patterns, such as flying wildly back and forth, rising rapidly, flying away, exploding, crashing, dragging a banner, etc. Another ComBOT™ might, for example, look like Dracula, and thus would have the appearance of the cartoon figure of Dracula. The pattern of behavior of this ComBOT™ would then include, for example, waving his cape, baring his teeth, tying a napkin around his neck and sharpening cutlery, shrinking back from the sun, etc. Thus, the patterns of behavior would differ from those of the first ComBOT™.

As described above, one and the same ComBOT™ can have different patterns of behavior, even for the same appearance, these different patterns of behavior being dependent on the communication device, user settings, time of the day, or language. The appearance may also change differently depending on the location at which the animation is to be executed, i.e., at the location of the sender of the message or at the location of the recipient of the message. Furthermore, the animation may be dependent on the size of the ComBOT™. Small ComBOTs™ are able to use more space for movement than ComBOTs™ in the form of large graphical elements. The type of a particular ComBOT™ may also be taken into account when storing different patterns of behavior appearances. The stored patterns of behavior may differ depending on the category of appearance, such as the categories of monster cartoon figure, etc.

In an embodiment according to the present invention, an event includes at least one from the group of received signal, transmitted signal, and local signal. In this manner, the playing of a movie file can be made dependent on an event, so that this signal can be played back in a location-dependent manner. That is to say, that at the location of the sender, the signal is displayed differently than at the location of the recipient, or that an animation occurring during a change in appearance of the individual ComBOT™ differs from that occurring in response to the receipt of an incoming signal. Similarly, in the case of a transmitted signal when, for example, the user of the ComBOT™ sends a message to his/her communication partner via this ComBOT™, the signal can be different than when a message is received. It is also possible to use local signals, such as status displays, animations for changing the visual appearance of the ComBOT™.

In an embodiment of the present invention, the movie file can be retrieved from a movie database. To be able to display the individual animations between the two ComBOTs™ or animations of the individual ComBOT™ alone, it is preferred to provide a movie database from which the individual movie files or sequences can be retrieved by the system and played back in the corresponding constellations of situations, so that the corresponding animation can be displayed for the respective ComBOT™. Since the representation of a ComBOT™ can preferably be freely selected by the user, and because the communication partner on the other end can also freely select the representation of his/her ComBOT™, a large combination of different animation options is provided, so that the different movies stored in the movie database can preferably be accessed depending on these ComBOTs™. Thus, depending on the selection of individual ComBOTs™, many different animations can be selected from the movie database and played back, be it for the individual ComBOT™ or for the interaction between two ComBOTs™.

In an embodiment according to the present invention, individual animations of the graphical elements can each have at least one movie file associated therewith. The individual animations of the graphical elements or ComBOTs™ may include, for example, the representation of moods of the individual ComBOTs™. Thus, it is possible, for example, that a specific ComBOT™ and the graphical representation thereof have the moods of happy, sad, hungry, sleepy, etc. associated therewith, and that these moods are then available for the individual ComBOT™ in a separate movie file, respectively.

In an embodiment according to the present invention, the communication animation is composed of various movie sequences. In particular, the communication animation includes a transformation sequence, a communication sequence, and a retransformation sequence.

Preferably, the individual animations, in particular the communication animation, are composed of several movie sequences. In this context, movie sequences are individual animated sequences representing a particular segment from a movie.

Preferably, a communication animations, includes at least three movie sequences: a transformation sequence, a communication sequence, and a retransformation sequence. The communication sequence embodies the actual (non-verbal) communication, which means that it contains, for example, the handing over of a bouquet of flowers from one ComBOT™ to the other. The preceding transformation sequence and the following retransformation sequence serve as bridging elements between the basic animation and the communication animation. The transformation sequence provides the transition or cut between the basic animation on the on hand, and the communication animation or sequence on the other hand.

In the process, the two ComBOTs™, which may have been selected to be of different sizes, may then be adapted in size, for example by the smaller ComBOT™ puffing up so as to assume a size equal to that of the other ComBOT™, before the actual communication sequence is played. It is also conceivable for other adaptations to occur in the transformation sequence. In the retransformation sequence, these adaptations are then reversed so as to make a cut to the basic animation. Thus, a continuous, well-animated animation can be provided for the interaction between two ComBOTs™.

In an embodiment according to the present invention, in the communication sequence, at least one graphical element has a representation or protagonist that differs from the representation in the basic animation. Preferably, the user and/or the communication partner of the user select the appearance of the graphical elements or ComBOTs™, so that they can choose the representation of the graphical element or ComBOT™ or the particular protagonist themselves. For example, he/she may be able to choose between different cartoon-like figures or animatable objects, and thus, to choose, for example, a little monster, a representation of Dracula, a representation of a robot, etc. The communication partner of the user can do that in the same way.

In this manner, an arbitrary number of different pairs of ComBOTs™ are produced, which have to be animated in a non-verbal communication sequence accordingly. This requires memory in the movie database, because then a suitable movie must be selected for each one of these pairs for each individual non-verbal form of communication. In order to save memory resources, it is preferred that one communication sequence featuring two special ComBOTs™ be provided for a specific non-verbal communication or animation, instead of having to provide such a sequence for each possible pair. In this manner, the communication sequence can be played by two protagonists that differ from the individual ComBOTs™ used in the basic animation. Thus, only one movie file must be available in the system for each animation option. For example, only one movie file for the greetings animation, one movie file for the anger animation, one animation for the amazement communication, etc.

In order to motivate this representation pleasantly for the user, the respective transformation sequences and retransformation sequences are preferably used to transform the representations of the ComBOTs™ or protagonists from the basic animation to the communication animation. Thus, for example, the transformation sequence may be to surround the individual ComBOTs™ with a glittering cloud that magically causes the protagonist to transform from the basic animation to the communication animation. In the retransformation sequence, this “magic transformation” can then be reversed. Then, the communication animation features two different protagonists. Of course, one of the protagonists may happen to be identical to one of the protagonists in the basic animation. In this manner, memory can preferably be saved by eliminating the need to provide animations and movie files for all possible combinations of ComBOT™ protagonists.

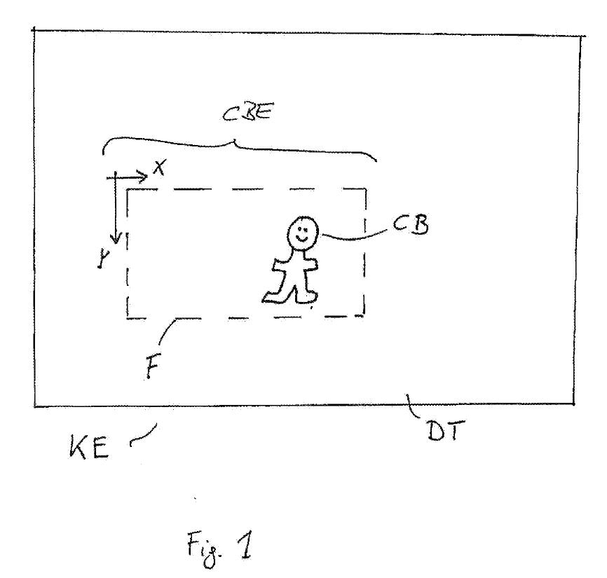

In FIG. 1, an embodiment of a communication system (KE) according to the present invention is shown in a schematic view. Shown is a desktop DT on which is provided a transparent window F, on which there is located a graphical element in the form of a ComBOT™ CB, which also serves as a control element. Therefore, such a CB element is not just a simple icon or an animatable symbol with graphical features, but has also functional features, in particular sensitive features, which respond to a mouse pointer or cursor and to mouse-controlled operations such as click, mouse-over, drag-and-drop, etc. Usually, such functional features are only associated with pure windows, but do not correspond to graphical elements.

The ComBOT™ CB shown here serves as a communication element having a graphical representation and functional features. It is defined, in particular, for an application program or client as an object having graphical and functional features, and has a run time environment that controls the graphical representation. In particular, this occurs in accordance with the functional features and/or states. With respect to the operating system, the ComBOT™ is defined, in particular, as an object having window features (e.g., drag-and-drop, move).

In order for these special graphical and functional features to be combined in a ComBOT™, it is not sufficient to utilize known desktop elements, such as icons or windows. This is because common icons are subject to the desktop array or grid, as discussed previously. On the other hand, common windows are not subject to the desktop array, and can be freely moved and changed in size, but are arranged hierarchically. Every sub-window has a so-called parent. The applications run in the windows. In this respect, the windows are the actual graphical user interfaces (GUIs).

The ComBOT™ CB proposed by an embodiment of the present invention has features of a window, but appears to the user as a controllable icon, and is capable of initiating operations, for example, by dragging and dropping. In order to implement a ComBOT™, it is preferred to access an API interface. In this example, the API of Windows 2000 or higher is used. There, a so-called “layered window” exists, i.e., a window whose properties or style are definable.

An embodiment of the present invention uses, in particular, the style property of “transparency”, and sets its value to 0. In this manner, window F becomes completely transparent. Window F then has 372×256 transparent pixels. Thus, a permanently defined “glass pane” is obtained, on which then the actual ComBOT™ image/animation CB is placed. Then, a so-called BINK player performs the animation of the ComBOT™. Preferably, the image format used is a format that has a so-called alpha channel, here, for example, the PNG format. Compared to other formats such as simple JPG, which have only the actual RGB pixel color values, the PNG pixels additionally have a transparency value, namely for the alpha channel mentioned above.

In accordance with an embodiment of the present invention, the sensitive features of ComBOT™ CB are then implemented by defining corresponding responsive areas (for example, for dragging and dropping). Contrary to common practice, the definition is not made using relative window coordinates X, Y. Rather, the inventive ComBOT™ element CB is checked to determine which pixels have a transparency value different from 0 (zero). These are then defined as the sensitive pixels or areas. This check can be performed by the operating system (for example, Windows 2000 or higher), and can be done particularly easily with PNG-like image data or image formats.

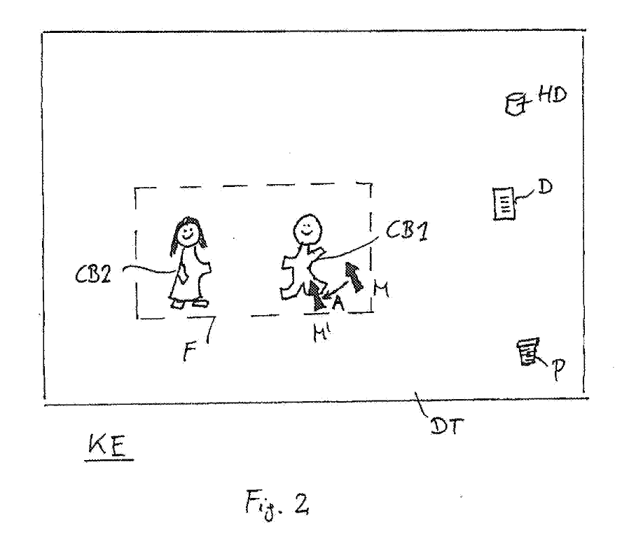

In FIG. 2 an embodiment of a communication system (KE) according to the present invention is shown in a schematic view. Here, a hard disk icon HD, an icon for a file D, and an icon for a recycle bin P can be seen on a user interface (desktop) DT. Ine addition, a transparent window F is provided, Window F is defined to be of such a size that even graphical elements can be displayed thereon as ComBOTS CB1 and CB2. A mouse pointer M is located on a first position, and is moved along arrow A to a second position of the mouse pointer, which is denoted by M′.

In this example, the ComBOTs™ are in the form of PNG files and are animated by means of a BINK player. They are located as window objects in a window. Window F is transparent, and therefore does not appear to the observer as a window. ComBOTs™ CB1 and CB2 are animated within this window as PNG files by means of a BINK player, and are located on the completely transparent window which has a size of 372×256 pixels and acts as a “glass pane” as a earner for up to two ComBOTs™. The ComBOT™ image is in the form of a PNG file, and the animation is carried out by the BINK player.

In the example, mouse M is then moved along the arrow from the first position to second position M′. While located on first position M, the mouse pointer can detect via the alpha channel of the PNG data that the transparency is set to zero, i.e., the pixel under the mouse pointer is completely transparent, whereas in position M′, it can detect that the alpha channel has a value different from zero. The responsive area, for example for dragging and dropping, is thus defined for the position of the mouse pointer, without requiring sensitive and non-sensitive areas or pixels to be defined using relative window coordinates X, Y. Instead, it is sufficient to check which pixels have a transparency value different from zero. These are then the sensitive pixels or areas. This check may preferably be performed by the operating system. Preferably, the check is performed via the alpha channel or PNG-like image data containing suitable additional information about transparency.

If now a drag-and-drop command is to be preformed, and, for example, the file D is to be moved onto ComBOT™ CB1, it may be detected, via the mouse pointer moving the file onto ComBOT™ CB1, either that the mouse pointer is not yet positioned over ComBOT™ CB1, or that, in position M′, it is already located over ComBOT™ CB1. The drag-and-drop command can then be completed by releasing the mouse button, and the area that is now detected to have a transparency different from zero, as a responsive area, can cause the underlying drag-and-drop command to be executed.

Thus, a ComBOT™ is essentially a window element, but appears to the user as a controllable icon which he/she may also use to perform drag-and-drop commands. Preferably, the API of Widows 2000 or higher is used, for example, for implementation purposes, using the “layered window” provided there, which is a window having a definable style. When the style property of transparency is set to zero, the window is completely transparent. Thus, when choosing a window having 372×256 transparent pixels, a permanently defined “glass pane” is created, on which then the actual ComBOT™ image/animation is placed. Preferably, the animation is executed by the so-called BINK player. Preferably, the image format used is a format having an alpha channel, in particular, the PNG format. Compared to other formats (such as simple JPG format) which have only the actual RGB pixel/color values, the PNG pixels additionally have a transparency value for the alpha channel mentioned above.

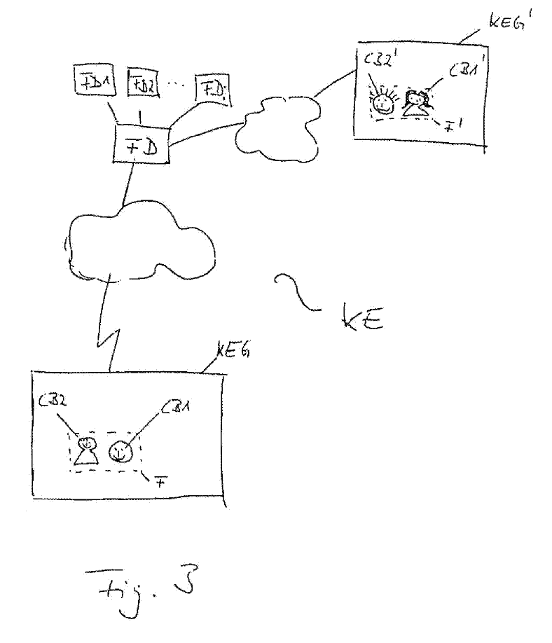

In FIG. 3, an embodiment of a communication system (KE) according to the present invention is shown in a schematic view. Shown are two different communication devices KEG and KEG′. Communication device KEG is associated with a user who himself/herself is represented by a ComBOT™ CB1, while communication device KEG′ is used by his/her corresponding communication partner on the other end.

There, the user is presented to the communication partner as a ComBOT™ CB2, since, on communication device KEG′ of the communication partner, he/she is laterally reversed, so that he/she is the communication partner of the user's communication partner. On the display screen of communication device KEG of the user, a transparent window F is shown, on which the two ComBOTs™ CB1 and CB2 are displayed. CB 1 is the representation of the user himself/herself, while CB2 is the representation of his/her communication, partner.

Communication device KEG can be connected to the Internet via a radio link and has access to movie files FD, which are organized in a database-like structure and include movie sequences FD1 through FDi. Communication device KEG′ can be connected to the Internet via a landline, and also has access to this database structure containing movie files FD. On communication device KEG′. ComBOTs™ CB1′ and CB2′ are displayed in a transparent window F′.

If the user of communication device KEG then initiates an animation intended to cause ComBOT™ CB1 to start a non-verbal communication with ComBOT™, CB2, this non-verbal communication will be displayed on communication device KEG in window F depending on the movie database and the type of communication device KEG. Movie database PD detects that communication device KEG is a PDA device that is connected to the Internet via a radio link. Therefore, a movie sequence FD1 is selected in order to display the non-verbal communication between ComBOT™, CB1 and CB2 on communication device KEG.

At the same time, movie database structure FD detects that communication device KEG′ is a personal computer connected to the landline network. For this reason, an animation FD2, which is larger and requires more computing power, is selected for display on communication device KEG′ in window FD between the two ComBOTs™ CB1′ and CB2′. Here, the representation takes place in exactly the opposite direction than in window F of communication device KEG, because here the user and the communication partner are exactly reversed. Movie database FD at the same time takes into account that it is already night at the location of KEG′, and selects FD2, which is a movie intended for this situation. If the animation had been required to be played during the day, then movie database PD would have selected a different movie to be played back on communication device KEG′.

Thus, in this example, the animation can be altered or changed depending on the properties of the particular communication device. The ComBOT™, while having the same appearance, can use different patterns of behavior, depending on the communication device and the time of the day.

Preferably, the movie file may have already been downloaded onto the communication device locally. Then, a selection can be made locally on the two communication devices KEG and KEG′.

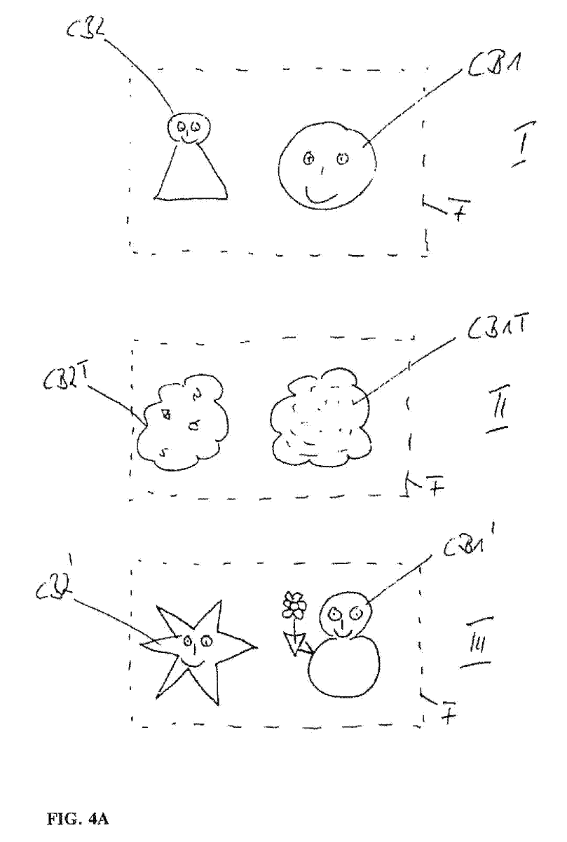

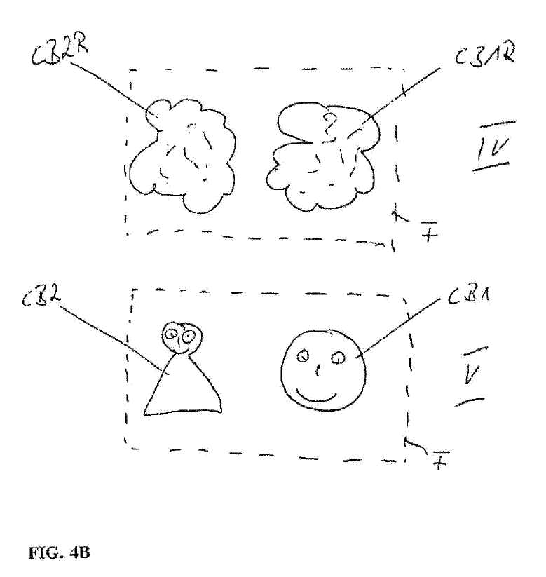

FIG. 4 shows in five sequences how, in an embodiment according to the present invention, an animation between two ComBOTs™ CB1 and CB2 may be displayed in a memory-saving form.

In FIG. 4 I, a first ComBOT™ CB1 and a second ComBOT™ CB2 are displayed in a transparent window F. First ComBOT™ CB1 is a representation of the user of the communication device, while ComBOT™ CB2 is a representation of the user's Communication partner on the other end of the communication channel. Here, the two ComBOTs™ CB1 and CB2 are shown in a basic animation. The user of CB1 then wishes to initiate a non-verbal communication directed to the communication partner represented by ComBOT™ CB2, and selects a greetings animation for this purpose. This animation may be produced by dragging and dropping onto ComBOT™ CB1 or CB2, or by selection from a suitable ComBOT™ menu.

FIG. 4 II shows a transformation sequence which is intended to transform the figure of CB1 from FIG. 4 I into a later representation CB1′ (see FIG. 4 III). This transformation representation of the ComBOT™ is denoted by CB1T. Here, a corresponding could of mist is displayed to symbolize the transformation. Such a cloud is also displayed at CB2T to symbolize the transformation of ComBOT™ CB2 into the later representation of protagonist CB2′.

In FIG. 4 III, the result of the transformation sequence is now presented in the form of the actual communication sequence. Protagonist CB1′ gives protagonist CB2′ a bouquet of flowers. This displays the selected greetings animation of the nonverbal communication between the two ComBOTs™. If, in order to save resources, the movie database contains a movie file for this animation only for the two protagonists CB1′ and CB2′, then this animation can now be played back, and the non-verbal communication can thus take place between the two ComBOTs™, without the need for a corresponding non-verbal communication animation to be available for any combination, such as, for example, the combination of CB1 and CB2.

FIG. 4 IV now shows the retransformation sequence in which ComBOTs™ CB1′ and CB2′ are retransformed into CB1 and CB2, respectively, in order to complete the communication animation shown in FIG. 4 III. The retransformation sequence selected here uses suitable transformation representations for the individual ComBOTs™ CB1R and CB2R. Here, too, clouds are displayed to symbolize a corresponding “magical” transformation.

In FIG. 4 V, the two initial ComBOTs™ CB1 and CB2 are shown in the basic animation again. Now, they symbolize the two representatives of the user on the one hand, and of the user's communication partner, on the other hand, in this ComBOT™ connection again. This allows a non-verbal communication between the two ComBOTS™ without the need for corresponding communication animations to be available in the form of movie files for all combinations of all conceivable ComBOTs™. Thus, a communication system is provided on which the ComBOT™ applications can be accessed in an animated manner.

While the invention has been particularly shown and described with reference to preferred embodiments thereof, it will be understood by those skilled tin the art that various changes in form and details may be made therein without departing from the spirit and scope of the invention.

What is claimed is:

1. A communication system for communicating, the system comprising:
a window-based graphical user interface, the window-based graphical user interface being displayable on a display device and comprising an area defined as a window, the area being displayed transparently; and
at least one graphical element, the at least one graphical element including, non-transparent pixels displayed in the window.

2. The communication system as recited in claim 1, wherein the non-transparent pixels define a responsive area operable to perform functional features associated with the at least one graphical element.

3. The communication system as recited in claim 2, wherein:
the at least one graphical element includes transparent pixels and includes an image format having a transparency-value channel operable to determine which pixels of the graphical user interface are transparent and which pixels are non-transparent so as to determine the responsive area.

4. The communication system as recited in claim 3, wherein the image format of the at least one graphical element includes a PNG format having an alpha channel.

5. The communication system as recited in claim 1, wherein the at least one graphical element is operable to be animated.

6. The communication system as recited in claim 5, wherein the at least one graphical element is operable to be animated by a BINK player.

7. The communication system as recited in claim 1, wherein the window is sized to accommodate at least two graphical elements.

8. The communication system as recited in claim 7, wherein the window has an area of 372×256 pixels.

9. The communication system as recited in claim 1, wherein the window is always displayed on a topmost display area of the display device or graphical user interface.

10. The communication system as recited in claim 1, wherein the at least one graphical element is operable to be transferred from a basic animation into a communication animation using a movie file.

11. The communication system as recited in claim 10, wherein the movie file is retrievable from a movie database.

12. The communication system as recited in claim 1, wherein the at least one graphical element includes an animation having a movie file associated therewith.

13. The communication system as recited in claim 10, wherein the communication animation includes a plurality of movie sequences.

14. The communication system as recited in claim 13, wherein the plurality of movie sequences includes at least one of a transformation sequence, a communication sequence, and a retransformation sequence.

15. The communication system as recited in claim 14, wherein in the communication sequence, the at least one graphical element includes a representation that differs from a representation in the basic animation.

16. The communication system as recited in claim 1 wherein the display is a display of a communication device, and wherein the at least one graphical element is operable to be animated by playing a movie file, the movie file being selectable depending on at least one of a property of the at least one graphical element, a property of the communication device, and an event to be represented.

17. The communication system as recited in claim 16, wherein the property of the communication device includes at least one of a class, type, model, software, and user preference.

18. The communication system as recited in claim 16, wherein the property of the at least one graphical element includes at least one of a category, size, and type.

19. The communication system as recited in claim 16, wherein the event to be represented includes at least one of a received signal, a transmitted signal, and a local signal.

20. A communication element comprising:
a transparently displayable window operable to be displayed on a window-based graphical user interface; and
at least one graphical element including non-transparent pixels in the window.

21. The communication element as recited in claim 20, wherein the non-transparent pixels, define a responsive area for performing functional features associated with at least one of the communication element and the at least one graphical element.

22. A computer readable medium having stored thereon computer executable process steps operative to perform a method for communicating, the method comprising:
providing a window-based graphical user interface, the window-based graphical user interface being displayable on display device and comprising an area defined as a window, the area being displayed transparently; and
providing at least one graphical element, the at least one graphical element including non-transparent pixels displayable in the window.
